(19) United States
(12) Patent Application Publication
(10) Pub. No.: US 2017/0141494 A1
(43) Pub. Date: May 18, 2017

(54) TERMINAL-EQUIPPED CIRCUIT BOARD

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Chuo-ku, Osaka-shi, Osaka (JP)

(72) Inventors: Yoshitaka Kami, Yokkaichi, Mie (JP); Tatsurou Sakai, Yokkaichi, Mie (JP); Yoshikazu Hachiya, Yokkaichi, Mie (JP); Mamoru Nagai, Yokkaichi, Mie (JP); Makoto Iwata, Yokkaichi, Mie (JP); Wenjie Shi, Yokkaichi, Mie (JP)

(21) Appl. No.: 15/300,123

(22) PCT Filed: Mar. 23, 2015
(86) PCT No.: PCT/JP2015/058712

§ 371 Date: Sep. 28, 2016

(30) Foreign Application Priority Data
Apr. 11, 2014 (JP) 2014-082254

(51) Int. Cl. H01R 12/58; H01R 13/52

(52) U.S. Cl. CPC H01R 12/58; H01R 13/521; H01R 2201/26

(57) ABSTRACT

An aim is to provide a terminal-equipped circuit board that has a novel configuration that is simple and can prevent a vehicle from catching fire after submersion. A terminal-equipped circuit board includes: a circuit board; and a plurality of terminals that are provided upright on the circuit board. The plurality of terminals include a positive terminal that is connected to a power supply line and a negative terminal that is connected to a ground line. At least one of the positive terminal and the negative terminal is enclosed by an impervious insulating tube member that is provided therearound. The positive terminal and the negative terminal are located adjacent to each other.

### CROSS-REFERENCE TO RELATED APPLICATIONS

This application is the U.S. national stage of PCT/JP2015/058712 filed Mar. 23, 2015, which claims priority of Japanese Patent Application No. JP 2014-082254 filed Apr. 11, 2014.

### FIELD OF THE INVENTION

The present invention relates to a terminal-equipped circuit board (a circuit board with terminals) that is housed within an electrical connection box for automobiles, for example.

### BACKGROUND

Conventionally, terminal-equipped circuit boards are housed in an electrical connection box for automobiles as an internal circuit. Examples of terminal-equipped circuit boards include: a terminal-equipped printed board that includes a printed board and a plurality of terminals that are connected to printed wiring of the printed board and are provided upright on the printed board; and a terminal-equipped wiring insulation board that includes a wiring insulation board and a plurality of terminals provided upright on the wiring insulation board. Power distribution from a battery to various loads is performed via the internal circuit constituted by the terminal-equipped circuit board, with high efficiency in terms of space.

Here, if water enters the inside of such an electrical connection box, there is the risk of a short circuit or the like occurring in the terminal-equipped circuit board. Therefore, measures are taken to waterproof the electrical connection box to a certain extent, taking into consideration the possibility that the electrical connection box gets wet during the use of the vehicle. For example, as disclosed in Japanese Patent No. 4585980, electrical connection boxes are known, such as an electrical connection box in which a gap in the casing of the electrical connection box is sealed by a sealing member or the like, and an electrical connection box in which a slope for discharging water is provided at an appropriate position within the casing so that water that has entered the inside is likely to be discharged.

However, the conventional waterproof configurations of an electrical connection box are only designed for usual usage of a vehicle, and needless to say, the waterproofing effect cannot be sufficiently achieved in unexpected cases where the electrical connection box is submerged due to a tsunami or a flood during a disaster such as the Great East Japan Earthquake. There have been many reports about cases in which vehicle fires occurred because of the terminal-equipped circuit board housed within the electrical connection box near the battery of the vehicle catching fire after unexpected submersion, and such cases have been gradually acknowledged as problematic.

There is an urgent need to conceive of some countermeasures that can prevent terminal-equipped circuit boards from catching fire after such an unexpected submersion. However, if a waterproofing configuration that takes submersion due to a tsunami, a flood, or the like, into consideration is adopted for an electrical connection box, the size and the cost of the electrical connection box increases. Besides, there is the possibility that such configuration hinders the functions of the electrical connection box during usual usage of the vehicle. Thus, such countermeasures are far from practical. Therefore, there is a demand for taking effective countermeasures to prevent terminal-equipped circuit boards from catching fire after submersion.

The present invention has been made in view of the above-described situation, and the problem is solved by providing a terminal-equipped circuit board that has a novel configuration that is simple and can prevent the vehicle from catching fire after submersion.

### SUMMARY OF INVENTION

The inventors of the present invention conducted a diligent study of the cause of a fire that occurs after the vehicle is submerged, and found that a fire occurs, particularly within the electrical connection box that is directly connected to the battery, at a portion of the circuit board where the positive terminal that is made of copper and is connected directly or indirectly to a power supply line, and the negative terminal that is made of copper and is connected directly or indirectly to a ground line, are located adjacent to each other. Specifically, when the vehicle is submerged in water containing electrolytes such as salt water, electrolysis occurs between the metal part of the positive terminal and the metal part of the negative terminal, which have a relatively large potential difference, and copper(I) oxide (Cu₂O), which is an oxide of copper, is deposited on the positive electrode. After the water has receded, the deposited copper(I) oxide accumulates between the positive terminal and the negative terminal, and a short circuit path of the accumulated copper(I) oxide is formed between them. When the temperature has increased to a certain degree, the copper(I) oxide with reduced resistance causes a short circuit. The inventors discovered that the insulation board is burnt with the heat generated during this process, and consequently a fire occurs. The inventors have completed the present invention based on this new discovery.

A first aspect of the present invention provides a terminal-equipped circuit board that is to be used in an electrical connection box for automobiles, the terminal-equipped circuit board including: a circuit board; and a plurality of terminals that are provided upright on the circuit board. The plurality of terminals include a positive terminal that is connected to a power supply line and a negative terminal that is connected to a ground line. A portion of the positive terminal exposed on the circuit board is enclosed by an impervious insulating tube member that is provided around the portion, the positive terminal being located adjacent to the negative terminal that is exposed on the circuit board. An end portion of the impervious insulating tube member on the circuit board side is brought into intimate contact with and fixed to the circuit board by a fixing means.

According to this aspect, at least one of the positive terminal and the negative terminal is enclosed by an impervious insulating tube member that is provided therearound. The positive terminal and the negative terminal are located adjacent to each other. Therefore, it is possible to advantageously prevent electrolysis from occurring between the positive terminal and the negative terminal that are adjacent to each other at the time of submersion, and consequently it is possible to prevent copper(I) oxide from being deposited. Therefore, even if copper(I) oxide accumulates between the positive terminal and the negative terminal, it is possible to advantageously prevent a short circuit path from being formed and causing a short circuit. As described above, it is possible to prevent a terminal-equipped circuit board from catching fire at the time of submersion, and it is eventually possible to prevent the occurrence of a vehicle fire, using a very simple structure in which the impervious insulating tube member is provided around and encloses at least one of the positive terminal and the negative terminal, without making any changes to the configuration of an existing terminal-equipped circuit board. Furthermore, according to this aspect, an end portion of the impervious insulating tube member on the circuit board side is brought into intimate contact with and fixed to the circuit board by a fixing means. Therefore, the copper(I) oxide accumulated on the circuit board is reliably prevented from approaching at least one of the positive terminal and the negative terminal. Consequently, it is possible to reliably prevent a short circuit path from being formed and connecting the positive terminal and the negative terminal to each other, and it is possible to more advantageously prevent the occurrence of a vehicle fire. Note that the fixing means may be a fitting structure including a recess and a protrusion that are provided for the impervious insulating tube member and the circuit board, or an adhesive or the like that fixes an end portion of the impervious insulating tube member and the circuit board to each other. Furthermore, according to this aspect, the impervious insulating tube member is provided around the positive terminal that is located adjacent to the negative terminal. Therefore, it is possible to efficiently prevent copper(I) oxide from being deposited due to electrolysis, and a short circuit path of copper(I) oxide from being formed, using a small number of impervious insulating tube members.

Note that the impervious insulating tube member only needs to be made of electrically insulating material that does not allow water to pass through it. For example, the impervious insulating tube member can be constituted by a tube made of rubber or elastomer, a tube made of synthetic resin, or the like. Also, the impervious insulating tube member only needs to be able to be provided around the terminal, and may be provided with a gap from the terminal, or provided in intimate contact with the terminal without a gap from the terminal. Furthermore, the impervious insulating tube member may have a circular cross section, an ellipsoidal cross section, or a polygonal cross section made by three, four, or more sides.

Also, examples of the terminal-equipped circuit board include a printed board on which a plurality of terminals that are connected to printed wiring are provided upright, and a wiring insulation board on which a plurality of terminals that are pressed against a single core line that has been arranged are provided upright on the wiring insulation board.

According to the aspects of the present invention, at least one of the positive terminal and the negative terminal is enclosed by an impervious insulating tube member that is provided therearound. The positive terminal and the negative terminal are located adjacent to each other. Therefore, it is possible to advantageously prevent electrolysis from occurring between the positive terminal and the negative terminal that are adjacent to each other at the time of submersion, it is possible to prevent copper(I) oxide from being deposited, and it is possible to advantageously prevent a short circuit path from being formed between the positive terminal and the negative terminal and causing a short circuit. As described above, it is possible to prevent a terminal-equipped circuit board from catching fire at the time of submersion, and it is eventually possible to prevent the occurrence of a vehicle fire, using a very simple structure in which the impervious insulating tube member is provided around and encloses at least one of the positive terminal and the negative terminal, without making any changes to the configuration of an existing terminal-equipped circuit board.

### BRIEF DESCRIPTION OF DRAWINGS

FIG. 1 is a perspective view showing a terminal-equipped circuit board according to a first embodiment of the present invention.

FIG. 2 is a cross-sectional view along a line II-II shown in FIG. 1.

FIG. 3 is a cross-sectional view of a terminal-equipped circuit board according to a second embodiment of the present invention, which corresponds to FIG. 2.

FIG. 4 is a cross-sectional view of a terminal-equipped circuit board according to a third embodiment of the present invention, which corresponds to FIG. 2.

### DETAILED DESCRIPTION OF THE PREFERRED EMBODIMENTS

The following describes embodiments of the present invention with reference to the drawings.

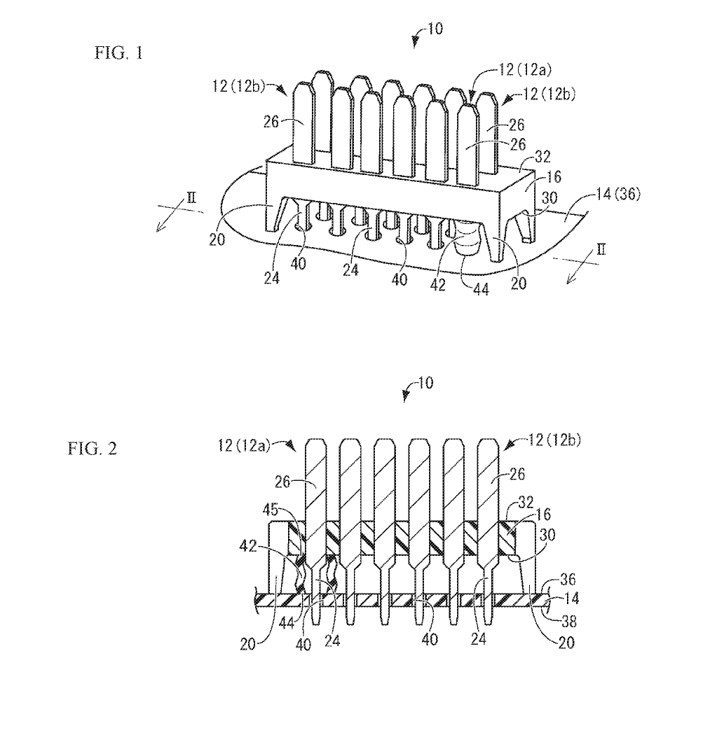

FIG. 1 and FIG. 2 show a terminal-equipped circuit board 10 according to a first embodiment of the present invention. The terminal-equipped circuit board 10 includes a circuit board 14 and twelve terminals 12 provided upright on the circuit board 14. In the following description, “upward direction” refers to the upward direction in FIG. 2, and “downward direction” refers to the downward direction in FIG. 2.

The terminals 12 are pressed into and fixed to a holding member 16 that is made of synthetic resin, and are held on the circuit board 14. More specifically, as shown in FIG. 1, the holding member 16 has approximately the shape of a block that is elongated in a horizontal direction, and legs 20 that each have an approximately rectangular cross section and that extend downward are respectively provided at the four corners of the holding member 16.

The terminals 12 each have a flat shape, and are formed by stamping a metal plate such as a copper plate whose surfaces is plated with tin or the like. One side of each terminal 12 in the lengthwise direction (the lower side in FIG. 2) is provided with a lead 24, and the other side of each terminal 12 in the lengthwise direction (the upper side in FIG. 2) is provided with a connector 26 that is wider than the lead 24. The respective leads 24 of the terminals 12 extend from a bottom surface 30 of the holding member 16 toward the circuit board 14, and the respective connectors 26 of the terminals 12 protrude upward from an upper surface 32 of the holding member 16.

The circuit board 14 includes an insulating board that is made of known insulating material such as glass epoxy resin and has an approximately flat shape, and a printed wiring board (not shown) provided on surfaces (an upper surface 36 and a lower surface 38) and an internal layer of the insulating board. The circuit board 14 is also provided with twelve through holes 40 that each have an approximately circular cross section and that penetrate through the circuit board 14 in a top-bottom direction. The leads 24 of the twelve terminals 12 are inserted through the through holes 40.

The leads 24 of the terminals 12 held by the holding member 16 are respectively inserted from above into the twelve through holes 40 of the circuit board 14 having such a configuration. The extent to which the leads 24 of the terminals 12 are inserted into the corresponding through hole 40 is determined by the four legs 20 on the holding member 16 being brought into contact with the upper surface 36 of the circuit board 14. Note that an impervious insulating tube member 42 that has the shape of a bellows with an approximately circular cross section is fitted onto the rightmost terminal 12 on the front side before the lead 24 of the terminal 12 is inserted through the corresponding through hole 40. Note that the impervious insulating tube member 42 is made of electrically insulating material that does not allow water to pass through it. For example, the impervious insulating tube member 42 can be advantageously constituted by a tube made of rubber or elastomer, a tube made of synthetic resin, or the like.

In the present embodiment, the rightmost terminal 12 on the front side, out of the twelve terminals 12, serves as a positive terminal 12a that is connected to a power supply line, and the remaining eleven terminals 12 serve as negative terminals 12b that are connected to a ground line, for example. Specifically, the impervious insulating tube member 42 is provided around the positive terminal 12a that is adjacent to one of the negative terminals 12b, and the positive terminal 12a is thus enclosed by the impervious insulating tube member 42. Here, the positive terminal 12a may be directly connected to a positive terminal of the battery serving as the power supply line, or indirectly connected to the positive terminal via another member. The negative terminals 12b may be directly connected to a negative terminal of the battery serving as the ground line, or indirectly connected to the negative terminal via another member. In short, two terminals 12 that have a potential difference and that are located adjacent to each other respectively constitute the positive terminal 12a and one of the negative terminals 12b. The positive terminal 12a may be a terminal 12 to which a voltage of 12V, 24 V, or 48V is applied, or a terminal 12 to which a voltage that is lower than 12 V is applied, for example. The negative terminals 12b may be terminals 12 to which a voltage of 0 V is applied, or terminals 12 to which a voltage that is higher than 0 V and lower than the voltage applied to the positive terminal 12a is applied. In the present embodiment, a voltage of 12 V is applied to the positive terminal 12a, and a voltage of 0V is applied to the negative terminals 12b.

When the terminals 12 are inserted into the through holes 40, the leads 24 of the terminals 12 are positioned and held in the state where their end portions protrude from the lower surface 38 of the circuit board 14. The impervious insulating tube member 42 has the shape of a bellows, and is elastic and is configured to expand and contract in the axial direction. Therefore, in the aforementioned state, the impervious insulating tube member 42, which has a length that is longer than the distance between the bottom surface 30 of the holding member 16 and the upper surface 36 of the circuit board 14, is compressed and deforms in the axial direction. Therefore, an end portion 44 on the circuit board 14 side and an end portion 45 on the holding member 16 side of the impervious insulating tube member 42 are pressed against the circuit board 14 and the bottom surface 30 of the holding member 16, due to the elastic restoring force of the impervious insulating tube member 42. The leads 24 are fixed to the through holes 40 by soldering (not shown), and the printed wiring (not shown) of the circuit board 14 and the terminals 12 are electrically connected together. The terminal-equipped circuit board 10 is thus constituted. Note that the respective connectors 26 of the terminals 12 are connected to, for example, connecter terminals of a connection counterpart (not shown). Specifically, portions of the terminals 12 other than the portions that protrude downward from the bottom surface 30 of the holding member 16 are enclosed by the holding member 16 or the housing of the connectors of the connection counterpart.

In the terminal-equipped circuit board 10 having such a configuration, the positive terminal 12a that is located adjacent to one of the negative terminals 12b is enclosed by the impervious insulating tube member 42. Therefore, it is possible to advantageously prevent electrolysis from occurring between the positive terminal 12a and one of the negative terminals 12b that are adjacent to each other when the terminal-equipped circuit board 10 is submerged. Therefore, it is possible to advantageously prevent copper(I) oxide from being deposited and accumulating between the positive terminal 12a and one of the negative terminals 12b that are adjacent to each other, and from forming a short circuit path. As described above, it is possible to prevent a terminal-equipped circuit board from catching fire after submersion, and it is eventually possible to prevent the occurrence of a vehicle fire, by adding, to an existing terminal-equipped circuit board, a very simple structure in which the impervious insulating tube member 42 is provided around and encloses the positive terminal 12a.

In addition, since the end portion 44 of the impervious insulating tube member 42 on the circuit board 14 side is pressed against the circuit board 14, even if copper(I) oxide is deposited and accumulates between the positive terminal 12a and one of the negative terminals 12b that are adjacent to each other, it is possible to reliably prevent a short circuit path from being formed around the positive terminal 12a that is enclosed by the impervious insulating tube member 42 on the circuit board 14, and to further advantageously prevent the occurrence of a vehicle fire.

Regarding the twelve terminals 12 provided upright on the circuit board 14, eleven negative terminals 12b are located around and adjacent to one positive terminal 12a. Therefore, by providing the positive terminal 12a with the impervious insulating tube member 42, it is possible to efficiently prevent copper(I) oxide from being deposited due to electrolysis, and a short circuit path of copper(I) oxide from being formed, using a small number of impervious insulating tube members 42.

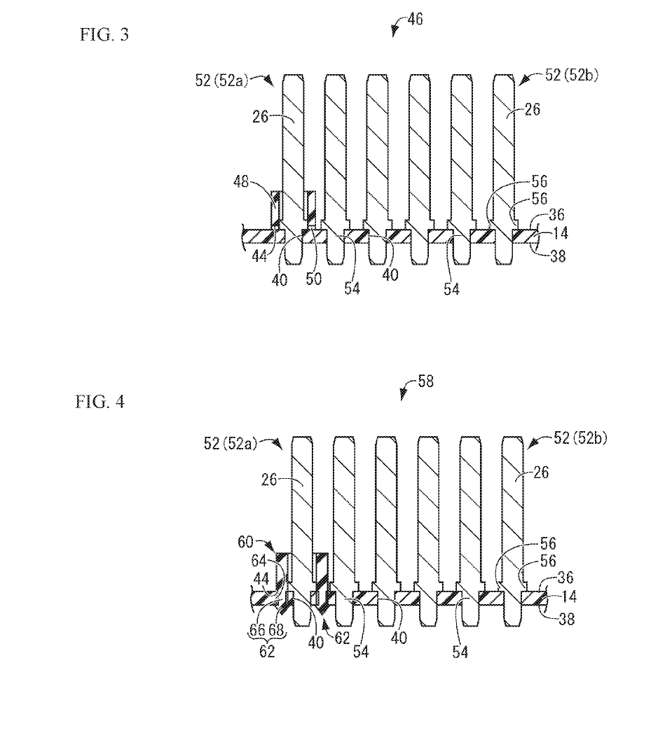

Next, a terminal-equipped circuit board 46 according to a second embodiment of the present invention will be described in detail with reference to FIG. 3. In this drawing, the components and portions that have the same configurations as in the above-described embodiment are given the same reference numerals as in the above-described embodiment, and their detailed description is omitted. The present embodiment is different from the above-described embodiment in that an end portion 44 of an impervious insulating tube member 48 on the circuit board 14 side is brought into intimate contact with and fixed to the circuit board 14 by an adhesive 50 that serves as “the fixing means”.

More specifically, in the present embodiment, unlike in the above-described embodiment, the holding member 16 for holding a terminal 52 in an upright state on the circuit board 14 is not provided. In the present embodiment, the holding member 16 is not provided, and instead, leads 54 of terminals 52 are wider and are able to be pressed into the through holes 40, and a pair of stoppers 56 that protrude in a direction that is orthogonal to the axial direction (in the left-right direction in FIG. 3) from a base end portion of each of the leads 54 are provided so that the terminals 52 can be held upright on the circuit board 14. The stoppers 56 determine the extent to which the leads 54 of the corresponding terminal 52 are inserted into the corresponding through hole 40. In the present embodiment as well, the impervious insulating tube member 48 is provided around and encloses a positive terminal 52a. Therefore, as with the above-described embodiment, it is possible to prevent electrolysis from occurring between the positive terminal 52a and a negative terminal 52b that are adjacent to each other at the time of submersion, and it is possible to prevent copper(I) oxide from being deposited. Moreover, although the holding member 16, by which the end portion 44 of the impervious insulating tube member 48 on the circuit board 14 side is pressed against the circuit board 14, is not provided, the end portion 44 of the impervious insulating tube member 48 on the circuit board 14 can be brought into intimate contact with and fixed to the circuit board 14 by the adhesive 50. Therefore, as with the above-described embodiment, it is possible to advantageously achieve the effect of preventing the terminal-equipped circuit board from catching fire when the terminal-equipped circuit board is submerged, and eventually preventing the occurrence of a vehicle fire.

Next, a terminal-equipped circuit board 58, which is a third embodiment of the present invention, will be described in detail with reference to FIG. 4. In this drawing, the components and portions that have the same configurations as in the above-described embodiments are given the same reference numerals as in the above-described embodiments, and their detailed description is omitted. The present embodiment is different from the above-described second embodiment in that the end portion 44 of an impervious insulating tube member 60 on the circuit board 14 side is brought into intimate contact with and fixed to the circuit board 14 by fitting protrusions 62 and fitting holes 64 that serve as “the fixing means”.

More specifically, in the present embodiment, unlike in the above-described second embodiment, the end portion 44 of the impervious insulating tube member 60 on the circuit board 14 side is provided with the fitting protrusions 62 that are located at opposite positions in a direction that is orthogonal to the axial direction (in the left-right direction in FIG. 4) and protrude downward, the circuit board 14 is provided with fitting holes 64 through which the fitting protrusions 62 are inserted. The fitting protrusions 62 each have approximately the shape of an arrow. An end portion of a rod-shaped extension portion 66 of each fitting protrusion 62 is provided with a protruding portion 68 that has approximately the shape of an inverted trigonal pyramid. The fitting holes 64 have a cross section that is larger than the cross section of the extension portions 66 of the fitting protrusions 62 and that is smaller than the cross section of the base end portions of the protruding portions 68 of the fitting protrusions 62. With such a configuration, in the terminal-equipped circuit board 58, the protruding portions 68 of the fitting protrusions 62 of the impervious insulating tube member 60 fitted onto the positive terminal 52a elastically deform, and consequently the fitting protrusions 62 can be inserted into the fitting holes 64 of the circuit board 14. After the end portion 44 of the impervious insulating tube member 60 on the circuit board 14 is brought into contact with the circuit board 14, the protruding portions 68 of the fitting protrusions 62 of the impervious insulating tube member 60 elastically restore to their original shape. Consequently, the base end portions of the protruding portions 68 are fitted to the peripheral portions of lower opening parts of the fitting holes 64, and thus the end portion 44 of the impervious insulating tube member 60 on the circuit board 14 is brought into intimate contact with and fixed to the circuit board 14. Therefore, as with the above-described second embodiment, it is possible to achieve the effect of preventing the terminal-equipped circuit board from catching fire when the terminal-equipped circuit board is submerged, and eventually preventing the occurrence of a vehicle fire.

A plurality of embodiments of the present invention have been described above in detail. However, the present invention is not limited to such specific details For example, although the impervious insulating tube member 42, 48, or 60 is provided around the positive terminal 12a or 52a in the embodiments, the impervious insulating tube member 42, 48, or 60, which has a ring-like shape, may be provided around the negative terminals 12b or 52b that are located adjacent to the positive terminal 12a or 52a. Also, the impervious insulating tube members 42, 48, and 60 only need to have a ring-like shape so that they can be provided around the terminals 12 or 52, and may have a circular cross section, an ellipsoidal cross section, or a polygonal cross section made by three, four, or more sides. Furthermore, the impervious insulating tube members 42, 48, and 60 may have the shape of a balloon instead of the shape of a bellows illustrated in the above-described first embodiment. In addition, the impervious insulating tube members 42, 48, and 60 only need to be able to be provided around the terminals 12 or 52, and may be provided with a gap from the terminals 12 or 52, or provided in intimate contact with the terminals 12 or 52 without a gap from the terminals 12 or 52. Also, the number and the arrangement of the terminals 12 and 52 and those of the positive terminals 12a and 52a and the negative terminals 12b and 52b that respectively constitute the terminals 12 and 52 may be freely determined.

The fixing means may be realized with, instead of the example shown in the embodiments, the bottom surface of a connecter attachment portion of an upper case such that the end portion 44 of the impervious insulating tube member 48 on the circuit board 14 side is pressed against the circuit board 14. Although the above-described connectors 26 have a flat shape, a configuration having the shape of a tuning fork or the like may also be adopted. In addition, examples of the terminal-equipped circuit boards 10, 46, and 58 naturally include a printed board on which a plurality of terminals that are connected to printed wiring are provided upright, and a wiring insulation board on which a plurality of terminals that are pressed against a single core line that has been arranged are provided upright on the wiring insulation board.

1. A terminal-equipped circuit board that is to be used in an electrical connection box for automobiles, the terminal-equipped circuit board comprising: a circuit board; and a plurality of terminals that are provided upright on the circuit board,
wherein the plurality of terminals include a positive terminal that is connected to a power supply line and a negative terminal that is connected to a ground line,
a portion of the positive terminal exposed on the circuit board is enclosed by an impervious insulating tube member that is provided around the portion, the positive terminal being located adjacent to the negative terminal that is exposed on the circuit board, and
an end portion of the impervious insulating tube member on the circuit board side is brought into intimate contact with and fixed to the circuit board by a fixing means.

2.-4. (canceled)
